(19) United States
(12) Patent Application Publication
(10) Pub. No.: US 2010/0319228 A1
(43) Pub. Date: Dec. 23, 2010

(54) DEVICE AND METHOD FOR SELLING A PROPERTY

(76) Inventor: Tim Yablonowski, Naples, FL (US)

Correspondence Address: ITALIA IP, 3500 WEST OLIVE AVE., SUITE 300, BURBANK, CA, 91505, US

(21) Appl. No.: 12/489,272

(22) Filed: Jun. 22, 2009

(51) Int. Cl. G09F 21/04; G09F 7/04; B43L 1/00

(52) U.S. Cl. 40/591; 434/408

(57) ABSTRACT

A magnetic sign and accompanying method for advertising a property is described. A sign with property information, and/or an owner/seller's contact information is magnetically attached to an automobile, effectively creating a mobile advertisement for a personal property. The inventive method may be utilized by private sellers, selling personal property, or by a larger entity, such as a real estate company.

### FIELD OF THE INVENTION

The present invention relates to magnetic signs. More specifically, this application relates to a magnetic sign with printed information and images that can be magnetically attached to a vehicle and utilized in a system for advertising a property that is for sale.

### BACKGROUND OF THE INVENTION

There are many advertising options available for one who wishes to sell one's home, car, boat, or any other personal property. One may choose to advertise through local real estate magazines, newspaper, internet, or any other local publication. The problem with all current forms of advertising is that the seller must pay a third party to publish their sale.

A seller who wishes to maximize their potential number of buyers must buy many forms of advertising in order to ensure that the property is sufficiently advertised. Advertising using the above mentioned methods has many disadvantages. One's property can easily blend in with the many other seller's listed in the same publication, and may be at risk of going unnoticed by potential buyers.

Further, while the conventional methods of advertising can result in a successful sale, one can become overwhelmed with the many fees associated with advertising their property.

There remains a need for people to efficiently and effectively advertise the sale of their properties at a low cost.

### SUMMARY OF THE INVENTION

The present invention approaches the issue of convenience by offering a seller the simple method of attaching a sign to their vehicle, advertising the sale of their property. The sign may attach magnetically to any portion of their vehicle that they see fit. Much like any known third party publication, the sign may consist of an image of the property for sale, along with any relevant description or information that goes along with said property, such as, price, quality, quantity, size, condition, etc. The sign may also consist of the seller's personal contact information, such as, phone number, address, email address, picture, etc. With the sign attached to a vehicle, the sale of the property is now advertised to any public which is able to view the sign.

While advertising a business or service on an automobile may be known in the field, the application discloses a novel method of advertising the sale of a property.

It is therefore an object of the invention to provide a sign that attaches to a vehicle, advertising the sale of a property.

It is another object of the invention to provide a magnetic sign that attaches to the metallic surface of a vehicle, comprising a top surface including indicia relating to the advertisement of a sale of at least one property, wherein the property being sold is a property other than the vehicle said magnetic sign is attached upon, and wherein the indicia includes a description and an image of the property being sold, and contact information of the seller; and a bottom surface including at least one magnetic portion for attachment of said magnetic sign to metallic surface of said vehicle.

It is another object of the invention to exploit serendipitous occurrence of would-be buyers and a vehicle.

It is a further object of the invention to utilize a sign that attaches to a vehicle, as a method of advertising a property.

These and other objects of the present invention will become readily apparent upon further review of the following specification and drawings.

### BRIEF DESCRIPTION OF THE DRAWING

Various objects, features, and attendant advantages of the present invention will become more fully appreciated as the same becomes better understood when considered in conjunction with the accompanying drawings.

FIG. 1 is a top plan view of the invention.

FIG. 2 is a perspective view of the invention shown in its environment, attached to an automobile.

FIG. 3 is a block diagram of steps of practicing the inventive method, and is read starting from the upper left.

### DETAILED DESCRIPTION

In general terms, the invention concerns a device and method for advertising a sale of a property to the public. More particularly, the invention seeks to exploit serendipitous proximity of the public and an advertisement that may occur in the course of travel of either the advertisement or the public.

While the present invention and method is described herein with reference to one illustrative embodiment, it should be clear that the present invention should not be limited to the one embodiment.

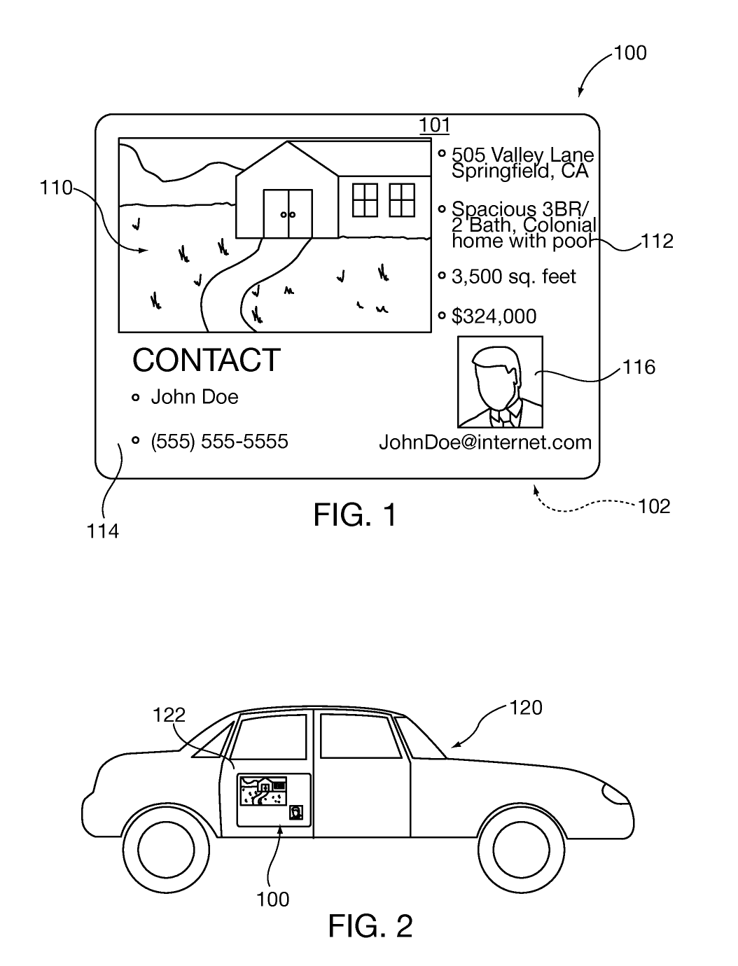

Referring now to FIG. 1, a magnetic sign 100 is shown. The magnetic sign 100 may consist of a top surface 101 and a bottom surface 102. On the top surface 101, various information and images relating to the property for sale may be printed thereon. As seen in FIG. 1, an image 110 of a house for sale is printed. Property information 112 relating to the property is also printed. The property information 112 may consist of but is not limited to: the location of the property, the size of the property, the price of the property, and/or any worthwhile features of the property. The printed information on the top surface 101 may also include contact information 114 of the seller/owner. The contact information 114 may consist of but is not limited to: the seller/owner's name, phone number(s), email address, company, or mailing address. A portrait 116 of the seller/owner may also be included. This aspect of the invention will be particularly advantageous to real estate agents.

It should be appreciated that the sign 100 may include a dry-erase portion on the top surface 101. Such a portion would be useful in anticipating properties or sellers with changing information (e.g. changing price or contact information).

Turning now to FIG. 2, an automobile 120 is shown with the magnetic sign 100 magnetically attached. The bottom surface 102 of the magnetic sign 100, will include any sort of magnetically adhering means. The bottom surface 102, may contain any plurality of magnetic strips, or is, perhaps, entirely magnetic. The bottom surface 102, is able to magnetically adhere to any metal surface, such as the metal surface 122 of the automobile 120. The magnetic bond between the metal surface 122 and the bottom surface 102 of the magnetic sign 100 will be strong enough so that the magnetic sign 100 will be in no danger of detachment when the automobile 120 is traveling at high speeds, but weak enough so that the magnetic sign 100 can be easily unattached when a person attempts to peel it off.

When attached to the metal surface 122, the sign 100 will be visible to any passerby of the automobile 120, and will thus, be a valuable form of advertisement.

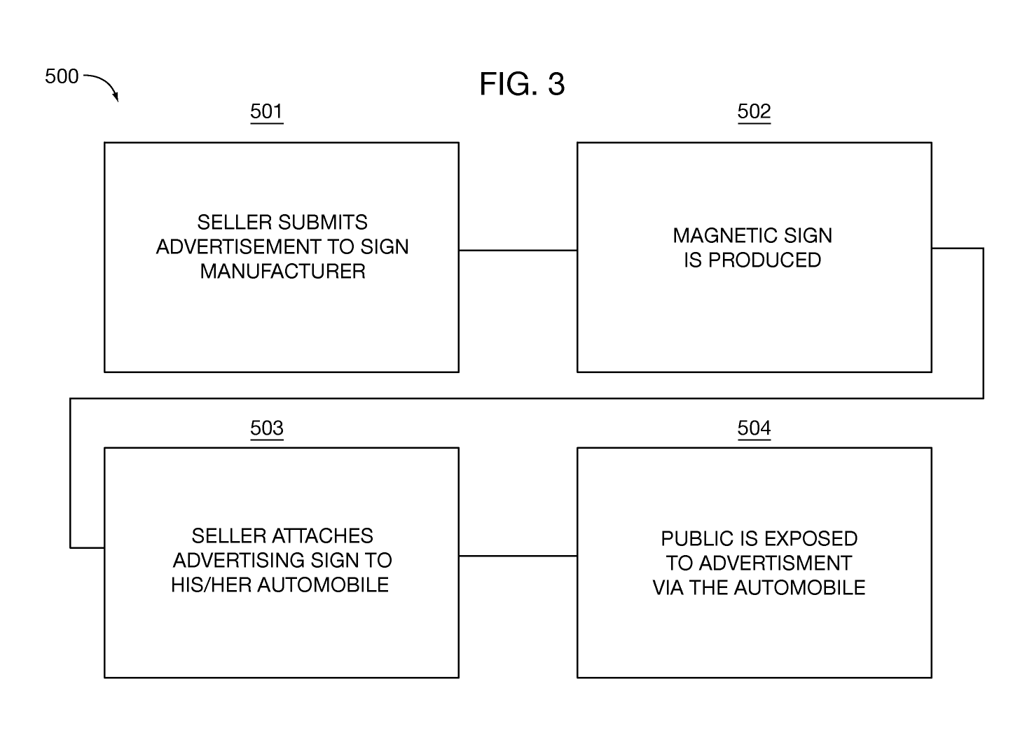

With the foregoing background in mind, and referring now to the flowchart of FIG. 3, which summarizes elements of the method 500, the novel method 500 may comprise the following steps.

A step 501 is that of an owner/seller's submitting an advertisement to be printed on the magnetic sign 100.

A step 502 is that of the magnetic sign 100 being produced according to the owner/seller's instructions.

A step 503 is that of the seller attaching the magnetic sign 100 to his/her automobile.

Lastly, a step 504 is that of the public being exposed to said advertisement via the automobile.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

What is claimed is:

1. A magnetic sign to be attached to the metallic surface of a vehicle, comprising:
a top surface including indicia relating to the advertisement of a sale of at least one property, wherein the property being sold is a property other than the vehicle said magnetic sign is attached upon; and
a bottom surface, wherein the bottom surface includes at least one magnetic portion for attachment of said magnetic sign to metallic surface of said vehicle.

2. The magnetic sign of claim 1, wherein the indicia relates to the seller of said property.

3. The magnetic sign of claim 1, wherein said magnetic portion of said bottom surface is integral to said top surface.

4. The magnetic sign of claim 1, wherein the bottom surface is substantially magnetic.

5. The magnetic sign of claim 1, wherein said magnetic sign is weather-proof.

6. The magnetic sign of claim 1, wherein the top surface further comprises a dry-erase portion.

7. A method of advertising the sale of at least one property, comprising the steps of:
attaching a sign containing indicia relating to said property to a vehicle, wherein the property being sold is a property other than the vehicle said sign is attached upon; and
utilizing the mobile nature of said vehicle to advertise said property to the public.

8. The method of claim 7, wherein the property is a house.

9. The method of claim 7, wherein the property is an automobile.

10. The method of claim 7, wherein the property is a boat.

11. The method of claim 8, wherein the indicia relates to the address of the property.

12. The method of claim 7, wherein the indicia relates to the size of the property.

13. The method of claim 7, wherein the indicia relates to the quality of the property.

14. The method of claim 13, wherein the indicia relates to the price of the property.

15. The method of claim 14, wherein the sign contains images relating to the property being sold.

16. The method of claim 15, wherein the sign contains indicia relating to the contact information of the seller.

17. A magnetic sign to be attached to the metallic surface of a vehicle, comprising:
a top surface including indicia relating to the advertisement of a sale of at least one property, wherein the property being sold is a property other than the vehicle said magnetic sign is attached upon, and wherein the indicia includes a description and an image of the property being sold, and contact information of the seller; and
a bottom surface, wherein the bottom surface includes at least one magnetic portion for attachment of said magnetic sign to metallic surface of said vehicle.

18. The magnetic sign of claim 17, wherein the indicia includes the price of the property being sold.

19. The magnetic sign of claim 17, wherein said magnetic portion of said bottom surface is integral to said top surface.

20. The magnetic sign of claim 19, wherein the bottom surface is substantially magnetic.
